(19) United States
(12) Patent Application Publication
(10) Pub. No.: US 2005/0133715 A1
(43) Pub. Date: Jun. 23, 2005

(54) Matrix with noise reduction additive and disposable target containing the same

(75) Inventors: Xiangping Zhu, Grafton, MA (US); Ioannis A. Papayannopoulos, Ashland, MA (US)

Correspondence Address: APPLIED BIOSYSTEMS, 500 OLD CONNECTICUT PATH, FRAMINGHAM, MA, 01701, US

(73) Assignee: Applied Biosystems, Framingham, MA (US)

(21) Appl. No.: 11/019,062

(22) Filed: Dec. 21, 2004

Related U.S. Application Data
(60) Provisional application No. 60/532,660, filed on Dec. 23, 2003.

(51) Int. Cl. H01J 49/00

(52) U.S. Cl. 250/288

(57) ABSTRACT

A matrix for mass spectrometry, the matrix comprising an additive that minimizes or eliminates adduct formation and/or chemical noise generation is disclosed. Also disclosed is a method for depositing a matrix on a MALDI target plate and a disposable plate having a dissolvable pre-matrix deposited thereon. The matrix material can be 2,5-dimethoxybenzoic acid and a monobasic or dibasic salt or tribasic salt as an adduct-reducing additive, such as ammonium monobasic phosphate and sulfate salts, dibasic citrate salts and tribasic citrate salts.

### CROSS REFERENCES TO RELATED APPLICATIONS

The present application claims the benefit of U.S. Provisional Application No. 60/532,660 filed Dec. 23, 2003. The entire contents of the foregoing provisional application are incorporated herein by reference in their entirety.

### INTRODUCTION

Matrix-assisted laser desorption/ionization (MALDI) analysis is a useful tool for solving structural problems in biochemistry, immunology, genetics and biology. Indeed, for the analysis of large molecules such as DNA, peptides, proteins and other biomolecules, mass spectrometry with MALDI ionization is a standard method. The task of the matrix material is to separate the analyte molecules (i.e., the substances to be analyzed) from each other, to absorb the energy imparted by the laser photons, and to transfer the energy to the analyte molecules, thereby resulting in their desorption and ionization. The choice of a matrix material for MALDI mass spectrometry analysis often depends upon the type of biomolecules analyzed, with more than a hundred different matrix materials having become known in the field over the past several years. Alpha-cyano-4-hydroxycinnamic acid (α-CHCA) has been widely used as matrix to facilitate the ionization of protein and peptide analytes in matrix-assisted laser desorption/ionization time-of-flight mass spectrometry. However, α-CHCA adducts form that can interfere with the ability to accurately detect low abundance, low mass analytes. Additionally, chemical noise is generated which also interferes with the analysis. Moreover, the solubility of α-CHCA is low in aqueous solutions typically used in the analysis of biomolecules, so if samples are spotted on top of dried α-CHCA matrix material, only a small amount of α-CHCA dissolves in the analyte solution and mixes with it to form analyte/matrix crystals resulting in lower sensitivity than when mixtures of sample and matrix are deposited. Another matrix material used to facilitate ionization of sample analytes is 2,5-dihydroxybenzoic acid (DHB). DHB also suffers from adduct formation and chemical noise generation that interferes with sample analysis. Although DHB is more soluble in aqueous solutions than α-CHCA, DHB typically crystallizes as a ring on the MALDI target, which presents difficulties for applications involving automated mass spectrometric analysis.

### SUMMARY

In accordance with the present teachings, a matrix material for MALDI mass spectrometry comprises 2,5-dihydroxybenzoic acid (DHB) and an additive that minimizes or eliminates adduct formation and/or chemical noise generation. The present teachings also provide a target for carrying out MALDI mass analysis. By “target”, we mean the structure, substrate or device used to position a sample for interfacing with a laser beam during MALDI mass spectrometry. Also provided is a method for depositing a matrix on a MALDI target and a disposable plate having a dissolvable pre-matrix deposited thereon.

In various embodiments, a matrix material is provided comprising 2,5-dimethoxybenzoic acid and a monobasic or dibasic salt as an adduct-reducing additive. The additives can be monobasic phosphates and sulfates, such as ammonium monobasic phosphate, and dibasic citrates, such as ammonium dibasic citrate.

In various embodiments, the present teachings are directed to a method of forming a substrate with pre-loaded matrix by depositing a matrix material comprising 2,5-dimethoxybenzoic acid and a monobasic or dibasic salt as an adduct-reducing additive on the substrate and drying the same under vacuum. A uniform matrix spot is formed which can attract a deposited analyte solution, such that the analyte disperses uniformly within the matrix. In various embodiments, sample analyte deposition can be effectuated either manually or with automated robotics. The present teachings are also directed to the substrate so formed. The substrate can include defined regions for locating the matrix material and for locating the sample analyte.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1A is a view of a deposited peptide solution on a DHB matrix on a substrate in accordance with the prior art;

FIG. 1B is the mass spectrum of the sample of FIG. 1A;

FIG. 2A is a view of a deposited peptide solution on a DHB matrix with the additive of the present teachings on a substrate;

FIG. 2B is the mass spectrum of the sample of FIG. 2A;

FIGS. 3A and 3B are views (at lower and higher magnification, respectively) of a MALDI target comprising a matrix material deposited within a defined region of the target in accordance with the present teachings;

FIGS. 4A and 4B are views of analyte solution deposited on the matrix materials of FIGS. 3A and 3B, respectively;

FIG. 5 is a top view of a MALDI target with pre-deposited matrix in accordance with the present teachings; and

FIG. 6 is a schematic depiction of a section of a MALDI target comprising concentric circles separated by a physical boundary made, for example, by laser etching. Matrix is deposited within the smaller inner circle and dried under vacuum in accordance with the present teachings. Analyte solution is deposited on the larger outer circle.

### DETAILED DESCRIPTION OF VARIOUS EMBODIMENTS

In the present description, the substances that are to be analyzed, including any biomolecules or biosubstances, are referred to as “analytes”. The terms “biomolecules” or “biosubstances” used herein include oligonucleotides (i.e., the essential building blocks of the living world), proteins, peptides and lipids, including their particular analogs and conjugates, such as glycoproteins or lipoproteins. Other substances that can be amenable to MALDI analysis within the present teachings are small molecules, metabolites, natural products and pharmaceuticals. As used in the present description, the analyte/matrix combination, including any adduct-reducing matrix additives, is referred to as the “sample”.

Analytes can be embedded in a matrix of light-absorbing material, which is generally present in large excess relative to the analyte. Samples are ionized and a mass spectrometer such as a time of flight (TOF) analyzer can be used to measure ion masses. Mass spectrometry can be a particularly powerful tool in the fields of drug discovery and development, genotyping, and proteome research. It has been found that incorporation of analyte molecules in some form into the usually crystalline matrix materials during their crystallization, or at least into the boundary surfaces between the small matrix crystals, is advantageous for the MALDI process.

Suitable substrates or targets are those conventionally used in MALDI TOF mass spectrometry. In various embodiments, the substrates are substantially planar, usually electrically conductive, and are dimensioned to fit in ionization chambers of the MALDI instrument. The substrates generally can be conductive metals, such as metals selected from the group consisting of gold, silver, chrome, nickel, aluminum, copper and stainless steel, but other rigid surfaces such as silicon or quartz can be used. The substrate materials can be inert to (and not interfere with) the operation of the device or the chemicals to be used in the procedure, including the matrix materials and solvents typical of MALDI mass spectrometry.

In various embodiments, the matrix material can be 2,5-dihydroxybenzoic acid (DHB) mixed with an additive capable of reducing chemical background such as the formation of adducts (e.g., matrix adducts) that are detected in mass spectra. Suitable additives can be volatile salts, particularly volatile monobasic, dibasic or tribasic salts, which are not too basic so as to not interfere with the sample being analyzed. The additives can be monobasic phosphates and sulfates, such as ammonium monobasic phosphate, and dibasic citrates, such as ammonium dibasic citrate, and tribasic citrates, such as ammonium tribasic citrate. The additive can be dissolved in water and then can be mixed with an aqueous solution of DHB to obtain the concentration of DHB of 5 mg/ml and the concentration of ammonium monobasic phosphate from about 1 to about 50 mM, or to obtain the concentration of DHB of 5 mg/ml and the concentration of ammonium dibasic citrate from about 1 to about 20 mM. The use of insufficient amounts of additive will not significantly reduce the adduct formation, while using too much additive can suppress the peptide signals in the mass spectra. Those of skill in the art will be able to determine without undue experimentation the appropriate amount of additive to optimize the analysis of a particular analyte.

With the addition of the additive to DHB in accordance with the present teachings, adducts such as matrix adduct peaks, along with chemical noise, are significantly reduced or eliminated in the MALDI mass spectra. Correspondingly, analyte peak intensities and signal-to-noise ratios are increased significantly. These improvements in the mass spectra permit the successful mass spectrometric analysis of samples contaminated with salts as well as the successful analysis of very low concentration (e.g., amol levels) analytes.

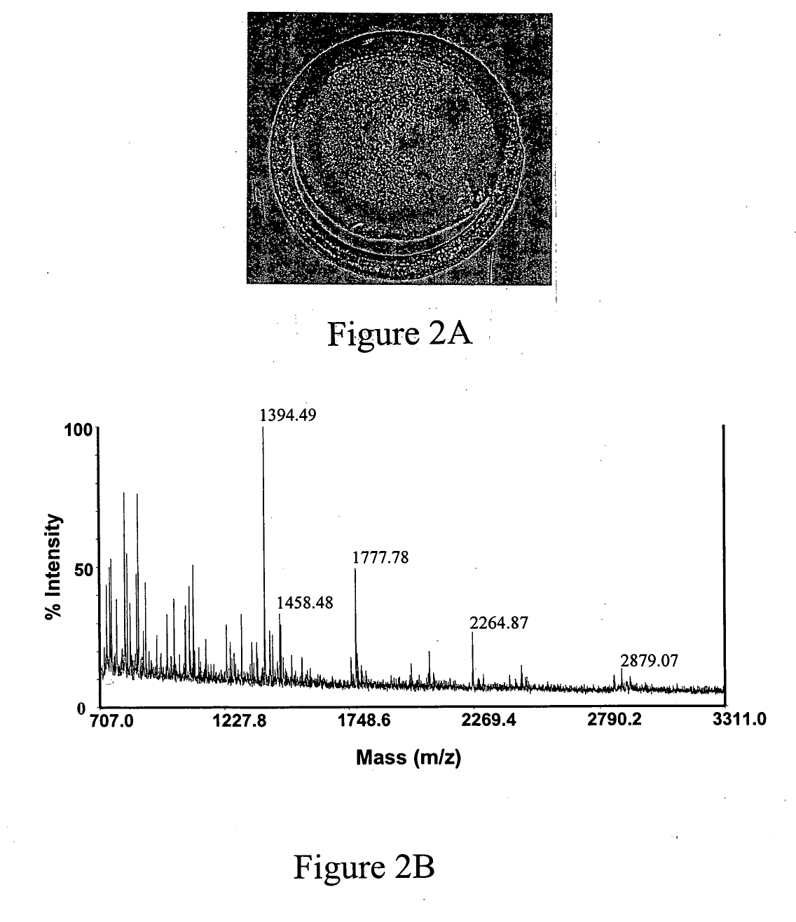

In various embodiments, matrix is deposited on the target to form discrete spots by dissolving the DHB in a solution comprising the adduct-reducing matrix additive of the present teachings and a suitable solvent, such as water or acetonitrile/water (50:50 by volume). The resulting solution is deposited on the MALDI substrate and the substrate can be placed in a vacuum chamber such that the DHB/adduct-reducing additive solution is dried under vacuum. Vacuum drying can result in a more uniform sample spot, that is crystallization of matrix with concomitant incorporation of analyte occurs over essentially the entire target sample spot as shown in FIG. 2A.

Various methods can be used for applying the analyte and matrix to a target plate. In various embodiments, the application of matrix involves pipetting a droplet of a solution of analyte and matrix onto a clean, metal (e.g., stainless steel) sample support plate. This droplet wets an area on the metal surface, the size of which corresponds approximately to the diameter of the droplet and is dependent on the hydrophobic properties of the metal surface and the characteristics of the droplet. After the solution dries, the sample spot consists of small matrix crystals spread over the formerly wet area. This analyte/matrix deposition process is referred to as the “dry droplet” method of sample preparation for MALDI mass spectrometric analysis. However, pre-mixing an analyte solution with the matrix solution for dry droplet deposition results in dilution of analyte, which can be problematic for low concentration analytes.

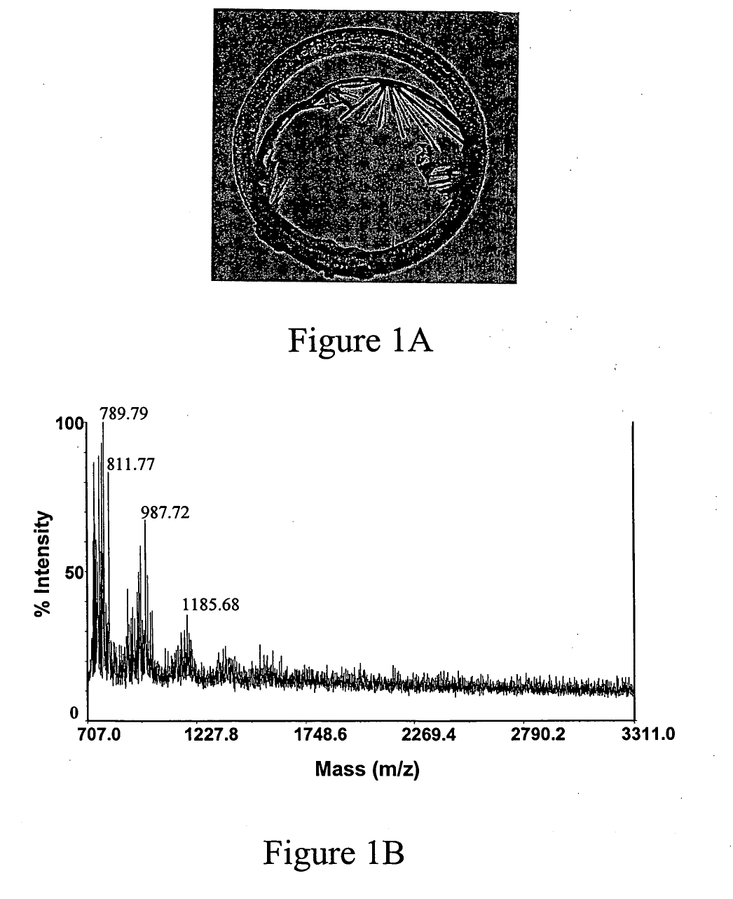

If DHB without the additive of the present teachings is used as the matrix material, the matrix/analyte crystals do not uniformly coat the previously wetted area. Instead, most of the small matrix crystals generally begin to grow at the periphery of the wetted area on the metal plate, growing toward the inside of the wetted area. This can result in the target sample spot shown in FIG. 1A.

In various embodiments, the matrix material can be deposited on the target first, with the analyte deposited later. The matrix deposit can be allowed to dry on the substrate, forming crystals of matrix as the solvent evaporates. Subsequent deposition of analyte solution on top of the dried matrix results in partial dissolution of the dried matrix deposit and co-crystallization of the redissolved matrix with the analyte. Using this method of sample preparation and deposition avoids analyte dilution; however, this process results in non-uniform crystallization with resultant non-uniform analyte dispersion in the matrix, thereby adversely affecting mass spectrometric analysis. In various embodiments involving high throughput MALDI mass spectrometry analysis utilizing robotics to transfer and deposit samples at high rates of sample processing, the sample plates used in the processing should have uniform surfaces on a plate-by-plate basis so as to provide improved reliability of the measured data. For high throughput automated sample analysis, the footprint area of the deposited samples for a fixed volume should also be uniform, small and predictable in order to utilize MALDI instrument software in automated data acquisition modes. Such a uniform sample spot also enables high throughput analysis by reducing the number of laser shots needed to create useful mass spectra, thereby saving time and avoiding excessive data processing.

Turning now to FIGS. 1A and 1B, there is shown in FIG. 1A a sample of matrix/analyte comprising DHB/peptide crystals (10 fmol β-galactosidase digest) deposited within a scribed region of a MALDI target plate in accordance with the dry droplet technique. As shown, most of the scribed region is devoid of sample, as the sample crystallizes as a ring. FIG. 1B illustrates the mass spectrum resulting from the analysis of this deposition. The low mass peaks in this spectrum were determined to be from the matrix, and peptide peaks were either suppressed or of weak intensity to be indistinguishable from background noise. The signal-to-noise ratio of the FIG. 1B spectrum particularly at higher mass values is low.

FIG. 2A illustrates another sample of matrix/analyte comprising DHB/peptides crystals (10 fmol β-galactosidase digest), but with the addition of ammonium monobasic phosphate in accordance with the present teachings, deposited within a scribed region of a MALDI target plate. As shown, the resulting deposition of sample is uniform, covering virtually the entire scribed region of the plate. FIG. 2B illustrates the superior quality of the resulting mass spectrum as compared to the spectrum illustrated in FIG. 1B, with most of the matrix peaks being suppressed and the peptide peaks (looking particularly at m/z values>1000) being prominent. Therefore, in the FIG. 2B spectrum both analyte signal intensity and signal-to-noise ratio were increased as compared to FIG. 1B.

The use of the matrix additive in accordance with the present teachings allows for the formation of uniform matrix spots on predetermined defined regions of a MALDI substrate. The addition of the additive eliminates the formation of crystals in a ring pattern as illustrated in FIG. 1A, and instead results in a uniform deposition in a predetermined defined region that enables the use of robotics for MALDI MS analysis as illustrated in FIG. 2A. In various embodiments, pre-spotted target can thus be formed. Even though the matrix material thus deposited can comprise either very fine crystals or be amorphous, the matrix material readily dissolves in the analyte solution when analyte is deposited on the dried matrix spot. Subsequent recrystallization with the analyte results in formation of bigger crystals that enhances mass spectrometric performance. Surprisingly, the sample spot size after sample analyte addition and recrystallization is very similar to the original matrix-only spot size, enhancing the ability to use automation for data acquisition.

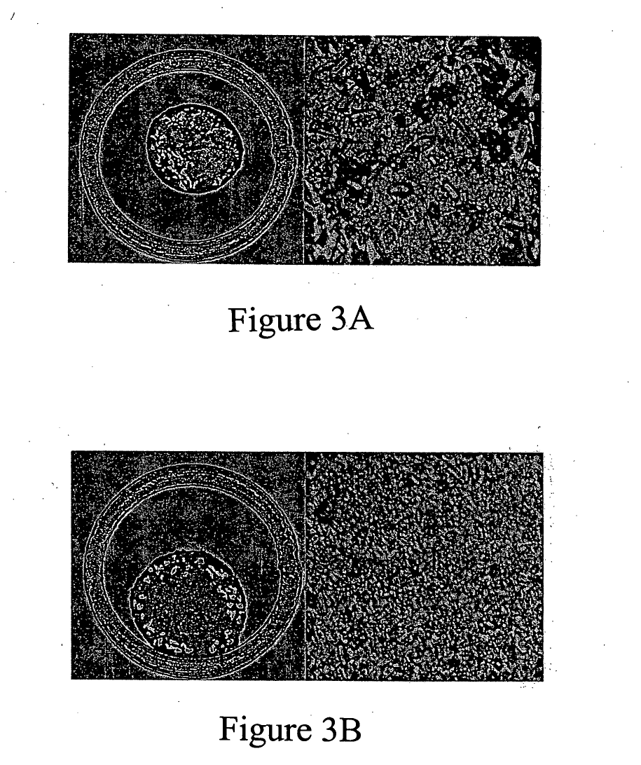

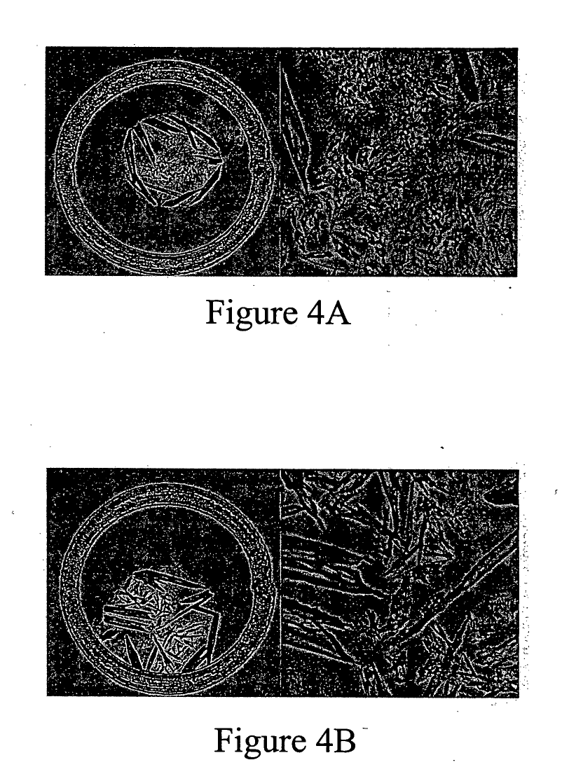

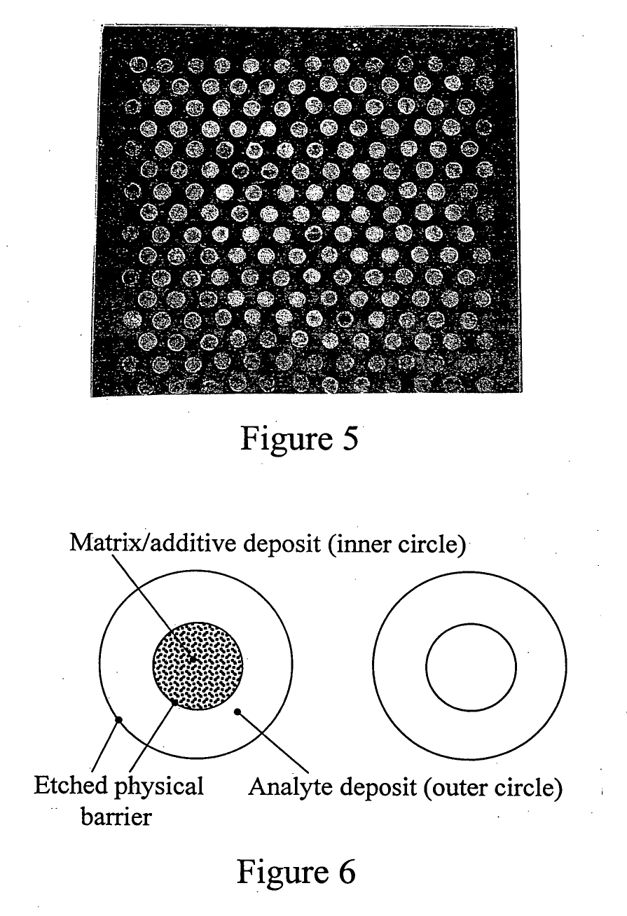

In addition, the vacuum dried DHB/additive spot results in a uniform spot which is generally circular. This spot tends to attract the analyte solution when it is deposited on top of the DHB/additive. Thus, the vacuum dried DHB/additive spot behaves as an anchor, attracting the analyte solution and preventing the unwanted spreading of the sample after analyte deposition. Accordingly, these matrix spots can be deposited at predetermined intervals (typically at regular intervals) across the surface of the MALDI substrate. FIG. 5 show a target plate with DHB and adduct-reducing additive in accordance with the present teachings pre-spotted on the plate in defined regions. FIGS. 3A and 3B illustrate a 0.5 μl solution of 5 mg/ml DHB and ammonium monobasic phosphate that was first deposited within a circular scribed area on a MALDI target and then vacuum dried. Analytes (e.g., 10 fmol of β-galactosidase) were subsequently deposited, manually or with an automated spotting robot, on top of the anchor spots and were allowed to dry, as shown in FIGS. 4A and 4B, respectively. Using this deposition technique, the sample solution shrank and dried down to the size of the original spot of the solid matrix/additive anchor. The anchors thereby define the location of the samples, and by using the anchor locations as coordinates on the target plate of FIG. 5 automated data acquisition by mass spectrometry instrument systems is facilitated by the present teachings. Upon completion of the analysis, the target plate can be washed and re-used, or can be readily disposed of.

In various embodiments, the substrate on which the matrix/additive material is deposited can contain at least one physical barrier in each region where a deposit is to be made. The physical barrier may be formed, for example, by laser etching of a metal substrate, resulting in a “trough” 0.005-010″ wide and 0.0005-0.001″ deep that is sufficient to retain within the barrier the typical volume of an aqueous solution used in MALDI mass spectrometry analysis. The physical barrier can be circular (as exemplified by the circular scribes shown in FIGS. 3A-4B), although other shapes and methods of formation are within the scope of the present teachings. In various embodiments, each region can be defined by a first physical barrier and can have an additional physical barrier located within the boundary of the first physical barrier, such as a smaller, scribed concentric circular region illustrated in FIG. 6. In this way, the matrix/additive spot can be deposited within the smaller region and vacuum dried as described previously, then the analyte containing sample can be deposited within the larger region. The matrix/additive material then attracts the deposited analyte solution, causing the analyte to migrate and become uniformly concentrated and dispersed within the matrix/additive inner region where it dries and is ready for analysis by MALDI mass spectrometry.

In various embodiments, the MALDI target plate can be coated with a hydrophobic material and the DHB/adduct-reducing additive can be applied directly to such hydrophobic surface. The provision of a hydrophobic surface on a MALDI substrate permits depositing samples having a smaller area and larger volume as compared to a metal substrate having a non-hydrophobic surface. Additionally, the hydrophobic surface greatly minimizes the spread of liquid across the surface, thus avoiding cross-contamination of analyte containing samples. However, the plate surface should not be so hydrophobic to cause the contact angle of the deposited liquid sample to be exceedingly high thereby reducing the footprint area of the deposited sample. Such reduction in area is undesirable since the laser used to desorb and ionize the sample has an increased probability of striking the sample plate rather than the sample during automated operation. This is undesirable particularly in tandem mass spectroscopy (MS/MS) processes, which often require relatively large samples, which, in turn, can require 10,000 to 100,000 or more exposures of the sample to the laser (shots). Suitable hydrophobic coatings that may be used to coat the target plates include synthetic waxes (e.g., paraffin waxes), natural waxes (e.g., bee's wax), lipids, esters, organic acids, silicon oils, or silica polymers, and mixtures thereof or as part of commercially available chemical compositions such as metal polishing paste or vegetable oils. The provisions for forming such a hydrophobic coating useful in the present teachings are described in U.S. patent application Ser. No. 10/227,088, whose disclosure is hereby incorporated by reference in its entirety.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

1. A matrix material for matrix-assisted laser desorption/ionization spectrometry comprising 2,5-dihydroxybenzoic acid and an adduct-reducing additive selected from monobasic phosphate and sulfate salts, dibasic citrate salts, tribasic citrate salts and any combination thereof.

2. The matrix material of claim 1 wherein the additive comprises ammonium monobasic phosphate.

3. The matrix material of claim 1 wherein the additive comprises ammonium monobasic sulfate.

4. The matrix material of claim 1 wherein the additive comprises ammonium dibasic citrate.

5. A target for matrix-assisted laser desorption/ionization spectrometry comprising a surface, a portion of which having deposited thereon a pre-loaded matrix comprising 2,5-dihydroxybenzoic acid and an adduct-reducing additive selected from monobasic phosphate salts, monobasic sulfate salts, dibasic citrate salts, tribasic citrate salts and any combination thereof.

6. The target of claim 5 wherein the pre-loaded matrix comprises vacuum-dried on the surface.

7. The target of claim 5 or 6 wherein the additive comprises ammonium monobasic phosphate.

8. The target of claim 5 or 6 wherein the additive comprises ammonium monobasic sulfate.

9. The target of claim 5 or 6 wherein the additive comprises ammonium dibasic citrate.

10. The target of claim 5 or 6 wherein the surface comprises a plurality of predetermined defined regions, and wherein each of the regions has deposited therein the matrix.

11. The target of claim 10 wherein each of the regions is defined by a physical barrier.

12. The target of claim 10 wherein the surface comprises a hydrophobic coating.

13. A method for making a target for matrix-assisted laser desorption/ionization spectrometry comprising:
a. depositing onto one or more predetermined defined regions of a sample support a matrix material comprising 2,5-dihydroxybenzoic acid and an adduct-reducing additive selected from monobasic phosphate and sulfate salts, dibasic citrate salts, tribasic citrate salts and any combination thereof; and
b. vacuum drying the matrix material.

14. A method for preparing a sample for matrix-assisted laser desorption/ionization spectrometry comprising:
a. depositing onto one or more predetermined defined regions of a target a matrix material comprising 2,5-dihydroxybenzoic acid and an adduct-reducing additive selected from monobasic phosphate and sulfate salts, dibasic citrate salts, tribasic citrate salts and any combination thereof;
b. vacuum drying the matrix material; and
c. depositing an analyte onto the target at each defined region corresponding to a dried matrix spot.

15. The method of claim 13, wherein the analyte is deposited by automated robotics.

16. The method of claim 14 wherein the predetermined defined regions comprise a physical barrier.

17. The method of claim 14 wherein the predetermined defined regions comprise inner and outer regions, each of the inner and outer regions comprising a physical barrier, wherein the matrix material is deposited within the inner region and wherein the analyte is deposited within the outer region, whereby the analyte migrates to the inner region.
